(19) United States
(12) Patent Application Publication
(10) Pub. No.: US 2007/0071902 A1
(43) Pub. Date: Mar. 29, 2007

(54) Rapid part fabrication employing integrated components

(75) Inventors: David M. Dietrich, St. Peters, MO (US); Orval M. Nobles, Dittmer, MO (US); Victor B. Slaughter, Manchester, MO (US); Ron DeFonce, High Ridge, MO (US)

Correspondence Address: TUNG & ASSOCIATES, Suite 120, 838 W. Long Lake Road, Bloomfield Hills, MI, 48302, US

(73) Assignee: The Boeing Company

(21) Appl. No.: 11/233,730

(22) Filed: Sep. 23, 2005

(51) Int. Cl. B05D 1/36

(52) U.S. Cl. 427/402; 427/407.1

(57) ABSTRACT

A part having an integrated, discrete component is produced by direct digital manufacturing and rapid, solid free-form fabrication techniques. A CAD file representing the part is modified to include an opening in the body of the part in which the component is to be inserted. The fabrication is performed by additive layering of a thermoplastic material, preferably using fused deposition modeling or stereolithography. The layering process is interrupted to allow the component to be inserted in the partially formed part, following which additional layers are added which secure the component in the part in place and complete the physical structure of the part.

### FIELD OF THE INVENTION

This invention generally relates to manufacturing processes, and deals more particularly with a method for manufacturing a part having an integrated component.

### BACKGROUND OF THE INVENTION

A wide array of manufactured parts incorporate individual components that are integrated or encapsulated into the body of the part during the manufacturing process. For example, components in the form of inserts are sometimes placed in a mold before molding material is introduced into a mold cavity surrounding the insert. Following molding, the inserted component becomes integrated within the part.

As an alternative to traditional manufacturing processes such as molding and machining, newer technologies are being used with increasing frequency to fabricate physical objects directly from CAD (Computer Aided Design) data files. These methods, also known as rapid prototyping, are unique in that they add and bond materials in layers to form the objects. Such technologies are sometimes referred to as free-form fabrication, solid free-form fabrication and layered manufacturing. These are additive type processes offering advantages in many applications, compared to molding or traditional subtractive fabrication methods such as milling or turning. For example, objects can be formed with high geometric complexity or intricacy without the need for elaborate machine setup or final assembly. Further, free-form fabrication reduces the construction of complex objects to manageable, straight forward and relatively fast processing.

Free-form fabrication technologies of the type described above are normally limited in their application to short production runs and monolithic parts. Therefore, where it is desired to add components such as connectors, sensors or other features, it is necessary to perform secondary operations on the free-form fabricated part such as drilling, screwing or molding components onto the part.

Accordingly, there is a need in the art for a method of free-form fabrication of parts with integrated, discrete components or inserts. The present invention is directed towards satisfying this need.

### SUMMARY OF THE INVENTION

According to one aspect of the invention, a method is provided for manufacturing a part having an integrated component, comprising the steps of using computer automated, solid free-form fabrication to combine successive layers of the material forming solid features of the part, and interposing the component between the layers as they are being formed in order to integrate the component into the layers. The fabrication process is carried out in three steps. First, several layers of material are combined to form a partially complete part. The layering process is then paused while the desired component is placed on the first set of layers and held in a fixed position. The remaining layers are then combined to cover and thereby integrate the component into the finished part. The free-form fabrication is preferably carried out using fused deposition modeling or stereolithography. The free-form fabrication process is directly controlled by a digital CAD file representing a drawing of the part.

In accordance with another aspect of the invention, a process is provided for producing a part having a body and a component integrated into the body, comprising the steps of flowing successive layers of a heated thermoplastic material on top of each other in a manner to form a body, and interposing the component between at least certain other layers such that the component becomes fixed within the body when the thermoplastic material solidifies after cooling. The layers are preferably formed by heating the thermoplastic material and extruding it from an extrusion head as a bead which is moved relative to the part to form the layers.

In accordance with still another aspect of the invention, a method of manufacturing a part having a body containing an integrated component comprises the steps of producing a CAD drawing file representing the part, generating a set of programmed instructions using the CAD drawing file, forming solid features of the body by using computer automated, solid free-form fabrication, controlling the computer automated fabrication using the programmed instructions, and interposing the component into the body while the solid features are being formed.

Various additional objects, features and advantages of the present invention can be more fully appreciated with reference to the detailed description and accompanying drawings that follow.

### BRIEF DESCRIPTION OF THE DRAWINGS

FIG. 1 is a perspective view of a part having an integrated component, manufactured using a process which forms the preferred embodiment of the invention.

FIG. 2 is a CAD drawing of the part shown in FIG. 1.

FIG. 3 is a flow diagram showing the steps for carrying out the process for manufacturing the part shown in FIG. 1.

FIG. 4 is a fragmentary, side view showing a portion of the part during the manufacturing process, immediately after insertion of a transparent window into a partially formed part body.

FIG. 5 is a diagrammatic view of a fused deposition modeling machine, suitable for carrying out the manufacturing process of the present invention.

FIG. 6 is an enlarged, side view of the liquifier head of the machine depicted in FIG. 5, one of the extrusion nozzles not being shown for sake of simplicity.

### DETAILED DESCRIPTION OF THE PREFERRED EMBODIMENTS

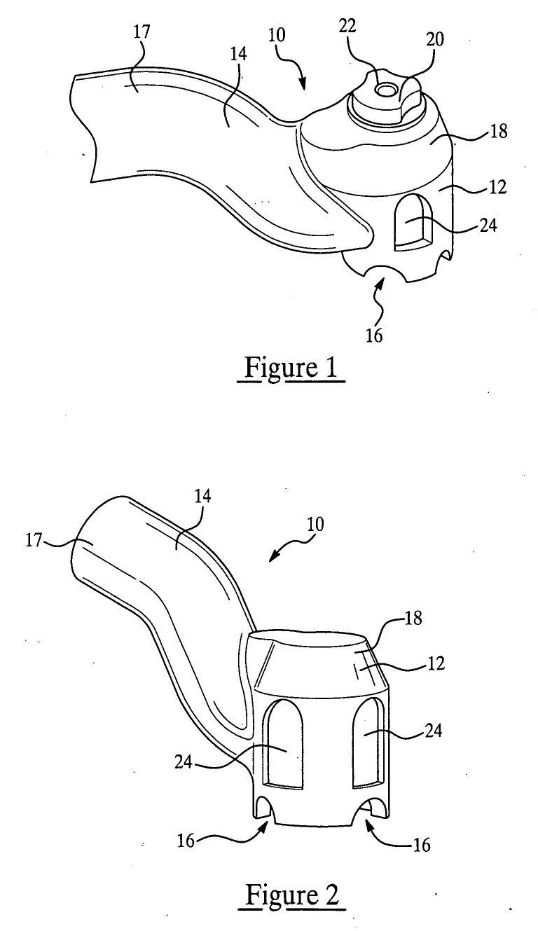

The present invention involves a method and process for manufacturing a part having an integrated or encapsulated component. An exemplary part that may be manufactured using the process of the present invention is shown in FIG. 1. A drill-guide tool, generally indicated by the numeral 10, is used guide a drill bit (not shown) and evacuate or remove chips that are produced when a hole is drilled in an object. The tool 10 includes a generally cylindrical, hollow head 12 and an open bottom intended to engage and cover an area of the object to be drilled, where the drill bit is intended to penetrate the object. A series of circumferentially spaced openings 16 are provided along the bottom of the head 12 which function to allow air to enter the head 12. The head 12 includes a domed top 18 provided with a central opening which receives a bushing 20 having a central through-hole 22 communicating with the open interior of head 12. The diameter of the through-hole 22 is essentially equal to that of the drill bit.

The tool 10 further includes a hollow neck 14 which communicates with the open interior of the head 12 and is provided with an outer end 17 that is circular in cross section. One or more clear plastic windows 24 are integrated into the side walls of the head 12 to allow a user to view the space inside the head 12, and more particularly, the exact location on the object where the drill bit will penetrate the object.

In use, a vacuum hose (not shown) is connected to the end 17 of the tool 10 while the user holds the tool 10 against an object to be drilled. The vacuum hose creates Suction in the neck 17, which draws in air through the openings 16 and evacuates workpiece chips from the head 12. The user inserts the drill bit into the through hole 22 until the tip of the bit contacts the object at the location where a hole is to be drilled. The user may view the tip of the drill bit through windows 24, in order to precisely position the tip at the exact location where the hole is to be drilled. The windows 24 also allow the user to view the operation of the drill, and particularly the production of workpiece chips to assure that the chips are being properly evacuated from the drill site.

In the past, it was difficult for a user to confirm that the drill tip was precisely located on the object due to the fact that the entire body of the part 10 was opaque, preventing the user from seeing the exact placement of the drill tip. Using the process of the present invention, however, a tool can be produced which is provided with clear plastic windows 24, thereby solving the problem of the user not being able to visually see the placement of the drill bit tip.

In accordance with the present invention a solid free-form fabrication technique is employed to manufacture the tool part 10, in which the part is formed by an additive layering process that combines plastic or other substances to create a solid object. The solid free-form fabrication technique is a type of so-called direct digital manufacturing in which the production process is directly controlled by a digital data file, typically a CAD data file.

Depending on the type of part to be fabricated, any of several well known, solid free-form fabrication techniques may be employed, such as stereolithography, 3-D ink jet printing or fused deposition modeling. In sterolithography, 3-D objects are constructed from liquid photosensitive polymers that solidify when exposed to ultraviolet light. The object is constructed on a platform that is situated just below the surface of a vat of liquid epoxy or acrylate resin. A low power, highly focused UV laser traces out the first layer, solidifying the model's cross section while leaving excess areas liquid. An elevator incrementally lowers the platform into the liquid polymer. A sweeper recoats the solidified layer with liquid, and the laser traces the second layer atop the first. This process is repeated, all under automated computer control, until the object is complete. Thereafter, the solid part is removed from the vat and rinsed clean of excess liquid. Part supports are broken off and the part is placed in an ultraviolet oven for complete curing.

In 3-D ink jet printing parts are built on a platform situated in a bin filled with powder material. An ink jet printing head selectively deposits or “prints” a binder fluid to fuse the powder together in the desired areas. Unbound powder remains to support the part. The platform is lowered, more powder added and leveled, and the process is repeated, all under automated computer control. When finished, the green part is removed from the unbound powder and excess unbound powder is blown off. The finished part is infiltrated with wax, glue or other sealants to improve durability and surface finish.

Fused deposition modeling (FDM), which will be described later in more detail, has been found to be particularly suitable as a fabrication technique in connection with the present invention. Briefly, in fused deposition modeling, filaments of heated thermoplastic are extruded from a tip that moves in an X-Y plane. A controlled extrusion head deposits very thin beads of material onto a platform to form the first layer. The platform is maintained at a temperature lower than the melting point of the thermoplastic so that the thermoplastic quickly hardens. After the platform lowers, the extrusion head deposits a second layer upon the first layer. Supports may be built during the layering process, which are fastened to the part, either with a second weaker material or with a perforated junction.

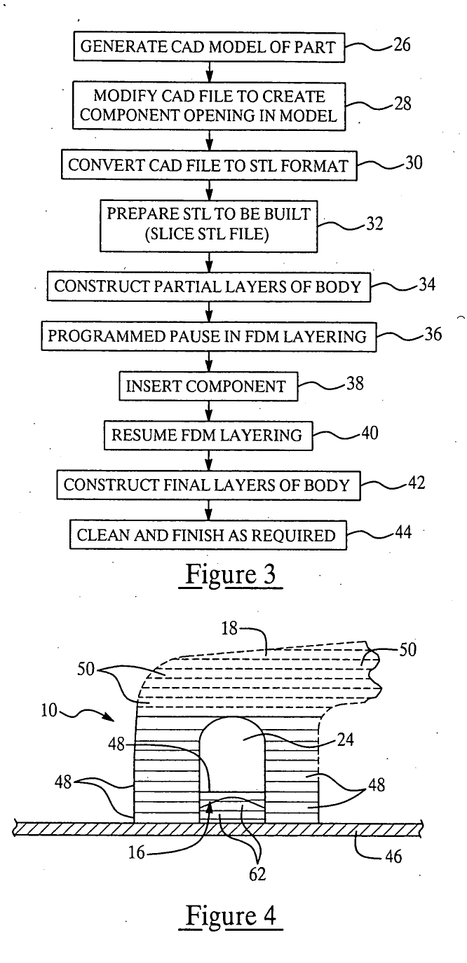

Reference is now made to FIGS. 2 and 3, which are useful in explaining the steps of the method used in the fabrication process of the present invention. As shown at 26, the first step involves generating a digital model of the part 10, which preferably is performed by producing a CAD (Computer Aided Design) model of the part 10 using any of a various of commercially available software packages. Other digital techniques can, of course, be employed to produce the digital file, providing that they result in accurately describing the theoretical dimensions and surface geometry of the part 10. The CAD software is essentially a surface modeler that builds a number of mathematical patches or surfaces that, when joined together, form the shape and dimensions of the desired part 10.

Next, at step 28, the CAD model file generated in step 26 is modified to create openings in the model corresponding to the shape and location of the windows 24. In order to assure that the part 10 is properly and completely modeled, the modified CAD file is then converted to STL file format, at step 30. The STL (stereolithography) file comprises a plurality of triangles or facets which define every feature of the part 10. Each facet is defined by the position of its three corners in space, and its direction, which distinguishes between internal and external surfaces of the part 10. Each facet is connected to three others at its edges, so that the total volume of the model may be enclosed.

With the digital CAD file having been converted to STL format, it is then processed at step 32 which involves slicing the model of the part 10 into a plurality of cross sections or thin layers. This is accomplished by dividing the CAD model with a series of closely spaced horizontal lines. The resulting file is an SLI or (slice) file which represents a series of closely spaced cross sections of the 3-D part model. The sliced STL file, which is in digital format, is then used to control a computer automated machine that performs solid free-form fabrication of the part, such as an FDM machine. Step 32 also includes programming an automatic pause in the operation of the FDM machine. As will become apparent below, this pause provides a brief interruption in the layering operation which allows an operator to insert a component into the partially formed part.

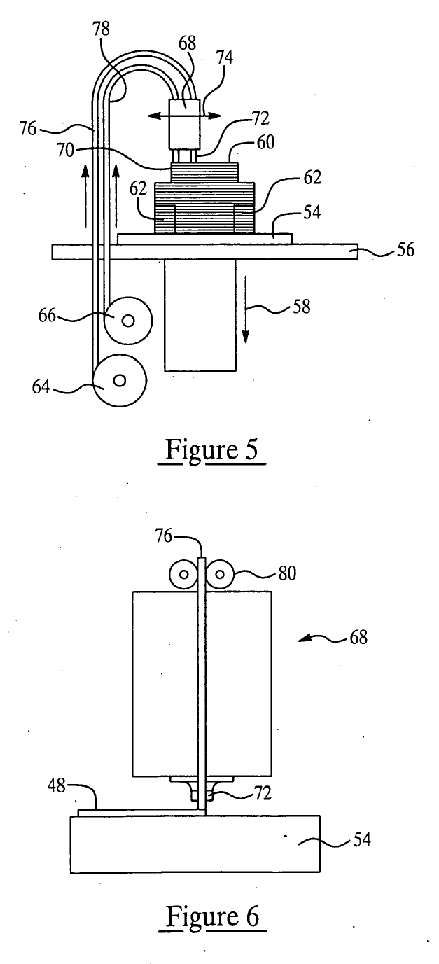

Referring now momentarily to FIGS. 5 and 6, an FDM machine generally indicated by the numeral 52 broadly includes a build platform 56 for supporting an object 60 to be built and a liquifier head 68 provided with extrusion nozzles 70-72 for dispensing beads of thermoplastic material used to form the object 60. The platform 56 is vertically movable along a Z-axis indicated by the arrow 58. The liquifier head 68 is movable along X or Y orthogonal axis indicated by the arrows 74. A spool 64 of build material and a spool 66 of support material are fed as thin filaments 76, 78 respectively to the head 68.

The head 68 includes feed rollers 80 which feed each filament 76, 78 through the body of the liquifier head 68 which is heated to a temperature slightly above the melting point of the filament, resulting in a flowable bead of the thermoplastic material passing through the extrusion nozzle 70, 72. As the head 68 is moved along the X-Y axes under computer control, a closely controlled bead is deposited, typically on a foam slab 54 supported by the build platform 56. FIG. 6 shows only a single nozzle 72, for sake of simplicity, in which a single layer 48 of the thermoplastic material has been initially deposited on the foam slab 54. The filament 78 of support material is used to form various supports and fixtures such as supports 62 which support various features or sections of the object 60 being formed.

As the head 68 is moved over the build platform 56 it deposits a thin bead 48 of extruded plastic to form each layer. The plastic hardens immediately after it is dispensed from the extrusion nozzles 70, 72 and bonds to the layer below. The entire FDM machine 52 is normally contained in an oven chamber which is held at a temperature just below the melting point of the thermoplastic. The support structures 62 are later removed from the object 60 in secondary operations simply by breaking them away from the object. Water soluble support materials are also available which can be removed simply by washing them away.

The filament 76 used to build the object 60 may comprise any of several commonly available materials such as ABS, polycarbonate or polyphenylsulfone. Where stereolithography techniques are used rather than FDM, the build material may comprise an elastomer or investment casting wax.

Referring now particularly to FIGS. 3 and 4, operating under control of the STL file, the next step 34 in the process involves constructing one or more initial layers 48 on a supporting surface 46, which may comprise the earlier described foam slab 54 (FIGS. 5 & 6). In the case of the illustrated tool part 10, these first few layers 48 form a lower portion of the part body and partially define an opening or slot into which the transparent plastic window 24 will be inserted.

After a predetermined number of initial layers 48 are formed, the FDM machine automatically pauses in its operation at step 36, and the component (in this case window 24) is then inserted at step 38, within the partially defined opening created by the space left between the initial layers 48. Although not shown in the drawings, the support filament 66 can be used to fabricate a fixture or support for holding the window 24 in place until the part is complete, following which the support may be removed.

With the component (window 24) having been inserted in the part opening, the FDM machine resumes operation at step 40. Subsequent layers 50 are then deposited, eventually covering all sides of the window 24 until the final layers of the body forming the part 10 are completed at step 42. It should be noted here that the component to be inserted, in this case a plastic window 24, should have a melting temperature greater than that of the filament material used to build the part.

Although this invention has been described with respect to certain exemplary embodiments, it is to be understood that the specific embodiments are for purposes of illustration and not limitation, as other variations will occur to those of skill in the art. For example, the invention is well suited to integrate or encapsulate various types of components into a part. Examples of these components would be sensors and RFID tags.

What is claimed is:

1. A method of manufacturing a part having an integrated component, comprising the steps of:
(A) using computer automated, solid free-form fabrication to combine successive layers of a material forming solid features of the part; and,
(B) interposing the component between the layers during step (A) so as to integrate the component into the successively combined layers.

2. The method of claim 1, wherein:
step (A) comprises combining a first set of layers to form a partially complete part, pausing during the free-form fabrication, and then combining a second set of layers to complete the part, and
step (B) comprises interposing the component between the first and second layers during the pause in the free-form fabrication.

3. The method of claim 1, wherein the material comprises a plastic thermosetting material.

4. The method of claim 1, wherein the material is selected from the group comprising ABS, elastomer, polycarbonate, polyphenolsulfone, and investment casting wax.

5. The method of claim 1, wherein the free-form fabrication is performed by fused deposition modeling.

6. The method of claim 1, wherein the free-form fabrication comprises:
melting a plastic material,
dispensing a bead of the melted plastic material from an extruder, and,
relatively moving the part being formed and the extruder such that the dispensed bead forms the successive material layers.

7. The method of claim 6, wherein the free-form fabrication includes allowing each material layer to harden before a successive layer of material is added.

8. The method of claim 1, wherein step (B) further comprises:
placing the component into contact with one of the layers of material, and
then, adding a successive layer of the material over the component to hold the component in a fixed position within the part.

9. The method of claim 6, wherein:
step (B) includes holding the component in a desired position while the component is in contact with the layer, and
step (A) includes adding successive layers of the material over the component while the component is being held in the desired position, thereby fixing the position of the component in the part.

10. The method of claim 1, further comprising the steps of:
(C) preparing a CAD drawing of the part;
(D) generating a digital data control file corresponding to the CAD drawing, wherein the component is represented by an opening in the part; and,
(E) using the digital data control file to control the computer automated fabrication.

11. A process for producing a part having a body and a component integrated into the body, comprising the steps of:
(A) flowing successive layers of a heated thermoplastic material on top of each other in a manner to form the body; and,
(B) interposing the component between at least certain of the layers while step (A) is being performed such that the component becomes fixed within the body when thermoplastic material solidifies after cooling.

12. The process of claim 11, wherein step (A) includes:
heating the thermoplastic material,
extruding the thermosetting material into a bead,
relatively moving the bead and the part to form the layers.

13. The process of claim 11, wherein step (A) is performed by fused deposition modeling.

14. The process of claim 11, wherein the material is selected from the group comprising ABS, elastomer, polycarbonate, polyphenolsulfone, and investment casting wax.

15. The process of claim 11, wherein:
step (A) includes dispensing a bead of the material from an extruder, and relatively moving the part being formed and the extruder such that the dispensed bead forms the successive material layers, and
step (B) is performed by holding the component in a preselected position contacting a layer of the material, and
step (A) further includes flowing additional layers over the component to thereby fix the component in the preselected position within the part.

16. The process of claim 11, further comprising the steps of:
(C) flowing successively layers of the heated thermoplastic material on top of each other to form a holding fixture; and,
(D) using the holding fixture to hold the component in a desired position until step (A) has been completed.

17. The process of claim 11, including the steps of:
(C) preparing a CAD drawing of the part;
(D) generating a digital control file corresponding to the CAD drawing, wherein the component is represented by an opening in the part;
(E) controlling the material flow in step (A) using a programmed computer; and,
(F) using the digital control file to control the operation of the computer.

18. A method of manufacturing a part having a body containing an integrated component, comprising the steps of:
(A) producing a CAD drawing file representing the part;
(B) generating a set of programmed instructions using the CAD drawing file produced in step (A);
(C) forming solid features of the body using computer automated, solid free-form fabrication;
(D) controlling the computer automated fabrication using the programmed instructions generated in step (B);
(E) interposing the component into the body while step (C) is being performed.

19. The method of claim 18, wherein:
step (D) includes interrupting the formation of the solid features, and
step (E) is performed while the solid feature formation is interrupted.

20. The method of claim 18, wherein step (C) is performed by fused deposition modeling.

21. The method of claim 18, wherein:
step (C) is performed by additively flowing layers of a plastic material on top of each other to form the solid features of the body, and
step (E) is performed by bring the component into contact with at least certain of the layers, and holding the component in a preselected position in contact with the certain layers while additional layers are flowed over the component to integrate the component into the body.
